(19) United States
(12) Patent Application Publication
(10) Pub. No.: US 2015/0186563 A1
(43) Pub. Date: Jul. 2, 2015

(54) Preconditioning Distinct Subsystem Models in a Subterranean Region Model

(71) Applicant: Halliburton Energy Services, Inc., Houston, TX (US)

(72) Inventors: Samuel Bryant Johnson, Spring, TX (US); Dylan Matthew Copeland, Katy, TX (US); Avi Lin, Houston, TX (US)

(21) Appl. No.: 14/144,129

(22) Filed: Dec. 30, 2013

(51) Int. Cl. G06F 17/50

(52) U.S. Cl. CPC G06F 17/5009

(57) ABSTRACT

In some aspects, techniques and systems for operating a subterranean region model are described. A global system model represents a subterranean region. Subsystem models of the global system model are identified. Each of the subsystem models represents a distinct subsystem within the subterranean region and is associated with a respective governing equation. The subsystem models can be preconditioned based on the respective governing equations of the subsystem models. The global system model that includes the preconditioned subsystem models can be preconditioned. The preconditioned global system model can be operated.

### BACKGROUND

This specification relates to preconditioning a subterranean region model. Subterranean region models typically include governing equations that can simulate the dynamics of a subterranean region. For example, some types models can be used to simulate fracture treatments, where fluids are pumped under high pressure into a rock formation through a well bore to fracture the formation.

### DESCRIPTION OF DRAWINGS

FIG. 1 is a diagram of an example well system.

FIG. 2 is a diagram of an example computing subsystem.

FIG. 3 is a diagram of an example system architecture

FIG. 4 is a flow chart of an example process for operating a subterranean region model.

FIG. 5 is a flow chart of an example preconditioning process.

Like reference symbols in the various drawings indicate like elements.

### DETAILED DESCRIPTION

Some aspects of what is described here relate to simulating a subterranean region in a well system environment. Some aspects of what is described here can be used to improve computational efficiency of a numerical simulation.

In some aspects, multiple different types of applied mathematical models are used to numerically simulate a subterranean region. For example, disparate subsystems in the subterranean region can be represented by disparate applied mathematical models within a global system model of the subterranean region, and the global system model can be used to simulate the subterranean region. The applied mathematical models can be incorporated in the global system model as discrete subsystem models that represent distinct physical subsystems (e.g., wellbores, fractures, rock blocks, reservoir media, etc.) associated with a stimulation treatment (e.g., an injection treatment, a flow back treatment, etc.) or other types of activities (e.g., production, drilling, etc.) in the subterranean region. In some examples, each subsystem model can be represented as a local system of equations (including local parameters and local variables), and the global system model can be represented as a combined system of equations that includes the local systems of equations from each subsystem and possibly additional equations, parameters, and variables.

In some implementations, the subsystems within the subterranean region interact with one another, and the subsystem models can be coupled to each other to simulate the interactions. For example, the dynamics of an individual subsystem may depend on the state of another, distinct subsystem due to the interaction among subsystems, and the solution of the various subsystem models may be interdependent on the solutions to the other subsystem models. In some cases, two or more subsystem models are tightly coupled in the global system model. For example, the global system model can include coupling models that provide connections between distinct subsystem models. The subsystem models (e.g., fracture models, wellbore models, reservoir models, rock block models, etc.) can represent the dynamics of the distinct subsystems, and the coupling models can represent coupling or other interactions among the subsystem models, so that the solution for each subsystem model can be influenced by the respective solutions for the other subsystem models.

In some instances, the global system model can be implicitly solved, for example, by solving the governing equations of tightly coupled subsystem models. The subsystem models can be tightly coupled, for example, by configuring the individual models (e.g., modifying the dimensions, units, numerical formulation of the governing equations, etc.) so that they can operate together and produce a common solution vector. Finding a common solution vector to the global system can include solving a global system that includes a large global coefficient matrix.

In some implementations, the global system model can be a large, poorly conditioned (or ill-conditioned) mathematical system. For example, a system is ill-conditioned if it has a high condition number, while it is well-conditioned if it has a low condition number. The condition number can measure how sensitive a function is to changes or errors in the input, and how the equations residual values compare to output errors. In the case of a system of equations represented in a matrix form with a coefficient matrix, the condition number can be defined, for example, as the ratio of the maximal singular value to the minimal singular values of the coefficient matrix. In general, a well-conditioned system can obtain a more stable solution and can be solved more efficiently and easily than an ill-conditioned system. In some instances, an ill-conditioned system may be transformed or otherwise manipulated to a better-conditioned system, for example, for efficient and stable solutions.

Preconditioning a model can include applying a preconditioner (e.g., a transformation or another type of preconditioner) that can condition a given problem into a form that is more suitable for numerical solution. For example, preconditioning can be applied to reduce a condition number of a problem. In some implementations, the preconditioner is represented in a matrix format and the preconditioning is applied as multiplying a vector by the preconditioner (e.g., computing a matrix-vector product). In some implementations, instead of a matrix format, the preconditioner can be implemented as another type of operator (or a function) acting on the vector. For instance, the preconditioner can take a vector as its input and return another vector as its output. In some implementations, the preconditioner can be used in iterative methods for solving a global system model. For example, the rate of convergence for most iterative linear solvers increases as the condition number of a matrix decreases due to the preconditioning.

In some implementations, the example techniques described here can improve the conditioning of the global system model, for example, by applying multiple levels of preconditioning. For example, low-level preconditioners (or local preconditioners) can be applied to the subsystem models independently and a global preconditioner can then be applied to the global system model. The low-level preconditioners can be designed to take advantage of the structure of the subsystem models to which they are applied, and the global preconditioner can be designed to efficiently correct a relatively small poorly conditioned subspace. The global preconditioner can be based on the method of deflation, Tikhonov iterations, or other techniques. In some implementations, the example preconditioning techniques are effective for multi-scale, multi-physics problems, with different types of mathematical equations and variables having widely varying spatial and temporal scales.

In some implementations, the techniques described here can provide one or more advantages. For example, the example techniques described here can provide efficient and accurate methods for solving a global system model that includes tightly coupled subsystem models. In some instances, due to the improved computational efficiency, the example techniques may enable real time processing of some or all aspects of a subterranean region simulation. Some types of global preconditioning can be implemented in a matrix-free representation. Matrix-free methods can solve a linear system of equations or an eigenvalue problem without explicitly storing the coefficient matrix explicitly. For example, instead of storing the coefficient matrix explicitly as a matrix, matrix-free methods may access the coefficient matrix by evaluating matrix-vector products. The example techniques described here can reduce memory requirements and computational cost through matrix-free implementation, for example, when the global coefficient matrix of the global system model is large. In some instances, the example techniques can be applied to applications where the global coefficient matrix is not explicitly available. Combinations of these or other advantages may be achieved in some cases.

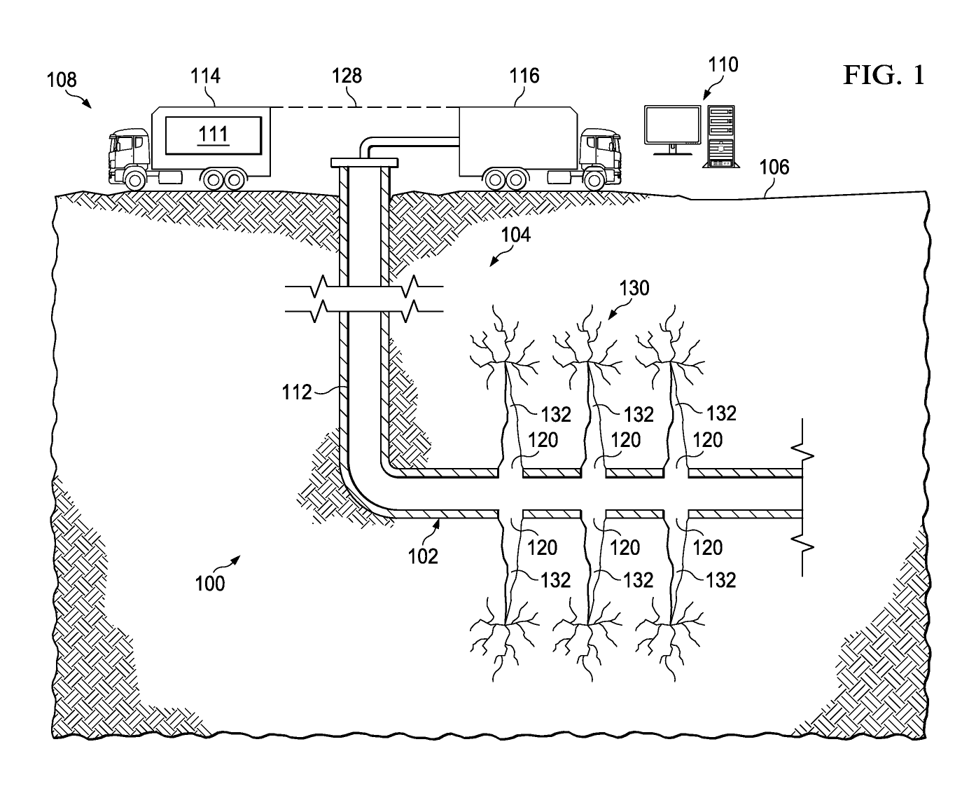

FIG. 1 is a diagram of an example well system 100 and a computing subsystem 110. The example well system 100 includes a wellbore 102 in a subterranean region 104 beneath the ground surface 106. The example wellbore 102 shown in FIG. 1 includes a horizontal wellbore; however, a well system may include any combination of horizontal, vertical, slant, curved, or other wellbore orientations. The well system 100 can include one or more additional treatment wells, observation wells, or other types of wells.

The computing subsystem 110 can include one or more computing devices or systems located at the wellbore 102 or other locations. The computing subsystem 110 or any of its components can be located apart from the other components shown in FIG. 1. For example, the computing subsystem 110 can be located at a data processing center, a computing facility, or another suitable location. The well system 100 can include additional or different features, and the features of the well system can be arranged as shown in FIG. 1 or in another configuration.

The example subterranean region 104 may include a reservoir that contains hydrocarbon resources such as oil, natural gas, or others. For example, the subterranean region 104 may include all or part of a rock formation (e.g., shale, coal, sandstone, granite, or others) that contains natural gas. The subterranean region 104 may include naturally fractured rock or natural rock formations that are not fractured to any significant degree. The subterranean region 104 may include tight gas formations that include low permeability rock (e.g., shale, coal, or others).

The example well system 100 shown in FIG. 1 includes an injection system 108. The injection system 108 can be used to perform a stimulation treatment that includes, for example, an injection treatment and a flow back treatment. During an injection treatment, fluid is injected into the subterranean region 104 through the wellbore 102. In some instances, the injection treatment fractures a rock formation in the subterranean region 104. In such examples, fracturing the rock may increase the surface area of the formation, which may increase the rate at which the formation conducts fluid resources to the wellbore 102.

The example injection system 108 can inject treatment fluid into the subterranean region 104 from the wellbore 102. For example, a fracture treatment can be applied at a single fluid injection location or at multiple fluid injection locations in a subterranean zone, and the fluid may be injected over a single time period or over multiple different time periods. In some instances, a fracture treatment can use multiple different fluid injection locations in a single wellbore, multiple fluid injection locations in multiple different wellbores, or any suitable combination. Moreover, the fracture treatment can inject fluid through any suitable type of wellbore such as, for example, vertical wellbores, slant wellbores, horizontal wellbores, curved wellbores, or combinations of these and others.

The example injection system 108 includes instrument trucks 114, pump trucks 116, and an injection treatment control subsystem 111. The example injection system 108 may include other features not shown in the figures. The injection system 108 may apply injection treatments that include, for example, a multi-stage fracturing treatment, a single-stage fracture treatment, a test treatment, a final fracture treatment, other types of fracture treatments, or a combination of these.

The pump trucks 116 can include mobile vehicles, immobile installations, skids, hoses, tubes, fluid tanks, fluid reservoirs, pumps, valves, mixers, or other types of structures and equipment. The example pump trucks 116 shown in FIG. 1 can supply treatment fluid or other materials for the injection treatment. The example pump trucks 116 can communicate treatment fluids into the wellbore 102 at or near the level of the ground surface 106. The treatment fluids can be communicated through the wellbore 102 from the ground surface 106 level by a conduit 112 installed in the wellbore 102. The conduit 112 may include casing cemented to the wall of the wellbore 102. In some implementations, all or a portion of the wellbore 102 may be left open, without casing. The conduit 112 may include a working string, coiled tubing, sectioned pipe, or other types of conduit.

The instrument trucks 114 can include mobile vehicles, immobile installations, or other suitable structures. The example instrument trucks 114 shown in FIG. 1 include an injection treatment control subsystem 111 that controls or monitors the injection treatment applied by the injection system 108. The communication links 128 may allow the instrument trucks 114 to communicate with the pump trucks 116, or other equipment at the ground surface 106. Additional communication links may allow the instrument trucks 114 to communicate with sensors or data collection apparatus in the well system 100, remote systems, other well systems, equipment installed in the wellbore 102 or other devices and equipment. In some implementations, communication links allow the instrument trucks 114 to communicate with the computing subsystem 110 that can run simulations and provide simulation data. The well system 100 can include multiple uncoupled communication links or a network of coupled communication links. The communication links can include wired or wireless communications systems, or a combination thereof.

The injection system 108 may also include surface and down-hole sensors to measure pressure, rate, temperature or other parameters of treatment or production. For example, the injection system 108 may include pressure meters or other equipment that measure the pressure of fluids in the wellbore 102 at or near the ground surface 106 or at other locations. The injection system 108 may include pump controls or other types of controls for starting, stopping, increasing, decreasing or otherwise controlling pumping as well as controls for selecting or otherwise controlling fluids pumped during the injection treatment. The injection treatment control subsystem 111 may communicate with such equipment to monitor and control the injection treatment.

The injection system 108 may inject fluid into the formation above, at or below a fracture initiation pressure; above, at or below a fracture closure pressure; or at another fluid pressure. The example injection treatment control subsystem 111 shown in FIG. 1 controls operation of the injection system 108. The injection treatment control subsystem 111 may include data processing equipment, communication equipment, or other systems that control injection treatments applied to the subterranean region 104 through the wellbore 102. The injection treatment control subsystem 111 may be communicably linked to a computing subsystem that can calculate, select, or optimize treatment parameters for initialization, propagation, or opening fractures in the subterranean region 104. The injection treatment control subsystem 111 may receive, generate or modify an injection treatment plan (e.g., a pumping schedule) that specifies properties of an injection treatment to be applied to the subterranean region 104.

In the example shown in FIG. 1, an injection treatment has fractured the subterranean region 104. FIG. 1 shows examples of dominant fractures 132 formed by fluid injection through perforations 120 along the wellbore 102. Generally, the fractures can include fractures of any type, number, length, shape, geometry or aperture. Fractures can extend in any direction or orientation, and they may be formed at multiple stages or intervals, at different times or simultaneously. The example dominant fractures 132 shown in FIG. 1 extend through natural fracture networks 130. Generally, fractures may extend through naturally fractured rock, regions of un-fractured rock, or both. The injected fracturing fluid can flow from the dominant fractures 132 into the rock matrix, into the natural fracture networks 130, or in other locations in the subterranean region 104. The injected fracturing fluid can, in some instances, dilate or propagate the natural fractures or other pre-existing fractures in the rock formation.

In some implementations, the computing subsystem 110 can simulate application of the injection treatments to the subterranean formation through one or more well bores. For example, the computing subsystem 110 can simulate and predict fracture initialization and propagation during injection treatments applied through the wellbore 102. The simulation may rely on an injection simulation system that can reflect the actual physical process of injection treatments. In some implementations, a global system model can be used to simulate the injection treatment applied on the subterranean region 104. For example, the global system model can include multiple subsystem models and that represent distinct subsystems, such as, for example, the wellbore 102, the natural fracture networks 130, the rock media in the subterranean region 104, or a combination of these and others. Each subsystem model can model distinct physical process associated with the respective subsystem within the subterranean region. The subsystem models can be connected by coupling models that represent interactions among the subsystem models.

A global system model can include fluid models, geo-mechanical models, fracture models, or other types of models. In some implementations, a global system model includes fluid models for simulating fluid flow in the well system 100. For example, the computing subsystem 110 can include flow models for simulating fluid flow in or between various locations of fluid flow in the well system (e.g., the wellbore 102, the perforations 120, the conduit 112 or components thereof, the dominant fractures 132, the natural fracture networks 130, the rock media in the subterranean region 104, or a combination of these and others). The flow models can model the flow of incompressible fluids (e.g., liquids), compressible fluids (e.g., gases), or a combination of multiple fluid phases. In some instances, the flow models can model flow in one, two, or three spatial dimensions. The flow models can include nonlinear systems of differential or partial differential equations. The computing subsystem 110 can use the flow models to predict, describe, or otherwise analyze the dynamic behavior of fluid in the well system 100. In some cases, the computing subsystem 110 can perform operations such as generating or discretizing governing flow equations or processing governing flow equations.

The computing subsystem 110 can perform simulations before, during, or after the injection treatment. In some implementations, the injection treatment control subsystem 111 controls the injection treatment based on simulations performed by the computing subsystem 110. For example, a pumping schedule or other aspects of a fracture treatment plan can be generated in advance based on simulations performed by the computing subsystem 110. As another example, the injection treatment control subsystem 111 can modify, update, or generate a fracture treatment plan based on simulations performed by the computing subsystem 110 in real time during the injection treatment.

In some cases, the simulations are based on data obtained from the well system 100. For example, pressure meters, flow monitors, microseismic equipment, tiltmeters, or other equipment can perform measurements before, during, or after an injection treatment; and the computing subsystem 110 can simulate fluid flow based on the measured data. In some cases, the injection treatment control subsystem 111 can select or modify (e.g., increase or decrease) fluid pressures, fluid densities, fluid compositions, and other control parameters based on data provided by the simulations. In some instances, data provided by the simulations can be displayed in real time during the injection treatment, for example, to an engineer or other operator of the well system 100.

Some of the techniques and operations described herein may be implemented by one or more computing systems configured to provide the functionality described. In various instances, a computing system may include any of various types of devices, including, but not limited to, personal computer systems, desktop computers, laptops, notebooks, mainframe computer systems, handheld computers, workstations, tablets, application servers, computer clusters, storage devices, or any type of computing or electronic device.

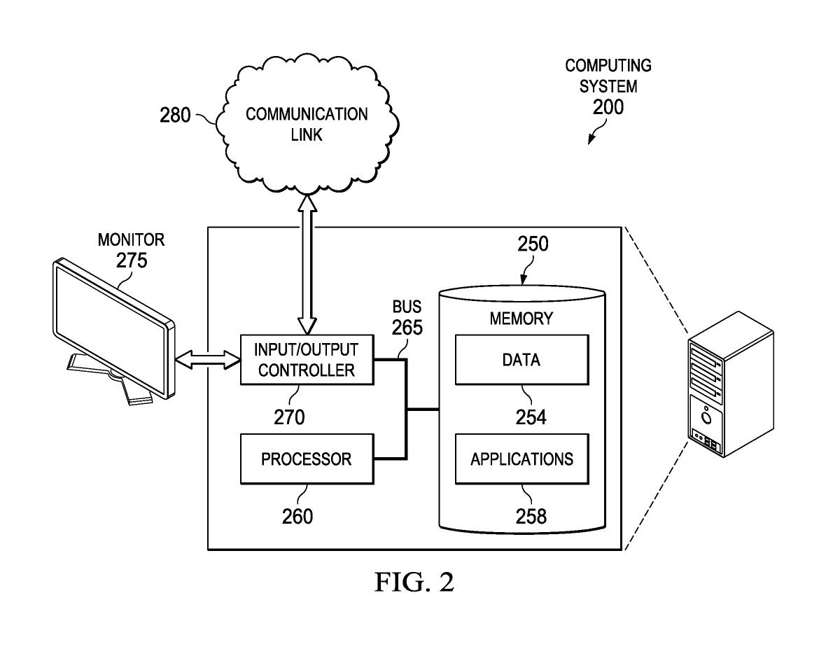

FIG. 2 is a diagram of an example computing system 200. The example computing system 200 can operate as the example computing subsystem 110 shown in FIG. 1, or it may operate in another manner. For example, the computing system 200 can be located at or near one or more wells of a well system or at a remote location apart from a well system. All or part of the computing system 200 may operate independent of a well system or well system components. The example computing system 200 includes a memory 250, a processor 260, and input/output controllers 270 communicably coupled by a bus 265. The memory 250 can include, for example, a random access memory (RAM), a storage device (e.g., a writable read-only memory (ROM) or others), a hard disk, or another type of storage medium. The computing system 200 can be preprogrammed or it can be programmed (and reprogrammed) by loading a program from another source (e.g., from a CD-ROM, from another computer device through a data network, or in another manner). In some examples, the input/output controller 270 is coupled to input/output devices (e.g., a monitor 275, a mouse, a keyboard, or other input/output devices) and to a communication link 280. The input/output devices can receive or transmit data in analog or digital form over communication links such as a serial link, a wireless link (e.g., infrared, radio frequency, or others), a parallel link, or another type of link.

The communication link 280 can include any type of communication channel, connector, data communication network, or other link. For example, the communication link 280 can include a wireless or a wired network, a Local Area Network (LAN), a Wide Area Network (WAN), a private network, a public network (such as the Internet), a WiFi network, a network that includes a satellite link, or another type of data communication network.

The memory 250 can store instructions (e.g., computer code) associated with an operating system, computer applications, and other resources. The memory 250 can also store application data and data objects that can be interpreted by one or more applications or virtual machines running on the computing system 200. As shown in FIG. 2, the example memory 250 includes data 254 and applications 258. The data 254 can include treatment data, geological data, fracture data, fluid data, or other types of data. The applications 258 can include flow models, fracture treatment simulation software, reservoir simulation software, or other types of applications. In some implementations, a memory of a computing device includes additional or different data, applications, models, or other information.

In some instances, the data 254 can include treatment data relating to injection treatment plans. For example the treatment data can indicate a pumping schedule, parameters of a previous injection treatment, parameters of a future injection treatment, or parameters of a proposed injection treatment. Such parameters may include information on flow rates, flow volumes, slurry concentrations, fluid compositions, injection locations, injection times, or other parameters.

In some instances, the data 254 include geological data relating to geological properties of a subterranean region. For example, the geological data may include information on wellbores, completions, or information on other attributes of the subterranean region. In some cases, the geological data includes information on the lithology, fluid content, stress profile (e.g., stress anisotropy, maximum and minimum horizontal stresses), pressure profile, spatial extent, or other attributes of one or more rock formations in the subterranean zone. The geological data can include information collected from well logs, rock samples, outcroppings, microseismic imaging, or other data sources.

In some instances, the data 254 include fracture data relating to fractures in the subterranean region. The fracture data may identify the locations, sizes, shapes, and other properties of fractures in a model of a subterranean zone. The fracture data can include information on natural fractures, hydraulically-induced fractures, or any other type of discontinuity in the subterranean region. The fracture data can include fracture planes calculated from microseismic data or other information. For each fracture plane, the fracture data can include information (e.g., strike angle, dip angle, etc.) identifying an orientation of the fracture, information identifying a shape (e.g., curvature, aperture, etc.) of the fracture, information identifying boundaries of the fracture, or any other suitable information.

In some instances, the data 254 include fluid data relating to well system fluids. The fluid data may identify types of fluids, fluid properties, thermodynamic conditions, and other information related to well system fluids. The fluid data can include flow models for compressible or incompressible fluid flow. For example, the fluid data can include systems of governing equations (e.g., Navier-Stokes equations, advection-diffusion equations, continuity equations, etc.) that represent fluid flow generally or fluid flow under certain types of conditions. In some cases, the governing flow equations define a nonlinear system of equations. The fluid data can include data related to native fluids that naturally reside in a subterranean region, treatment fluids to be injected into the subterranean region, hydraulic fluids that operate well system tools, or other fluids that may or may not be related to a well system.

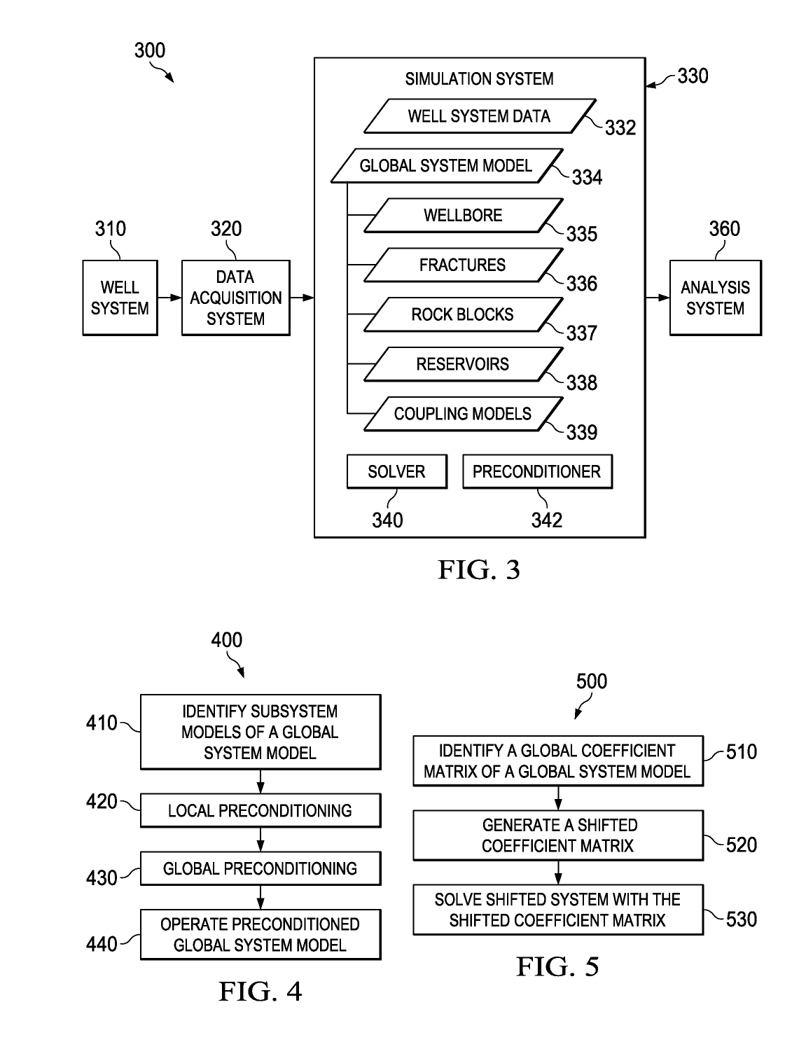

The applications 258 can include software applications, scripts, programs, functions, executables, or other modules that are interpreted or executed by the processor 260. For example, the applications 258 can include a fluid flow simulation module, a hydraulic fracture simulation module, a reservoir simulation module, or another other type of simulator. The applications 258 may include machine-readable instructions for performing one or more of the operations related to FIGS. 3-5. The applications 258 may include machine-readable instructions for generating a user interface or a plot, for example, illustrating fluid flow or fluid properties. The applications 258 can receive input data such as treatment data, geological data, fracture data, fluid data, or other types of input data from the memory 250, from another local source, or from one or more remote sources (e.g., via the communication link 280). The applications 258 can generate output data and store the output data in the memory 250, in another local medium, or in one or more remote devices (e.g., by sending the output data via the communication link 280).

The processor 260 can execute instructions, for example, to generate output data based on data inputs. For example, the processor 260 can run the applications 258 by executing or interpreting the software, scripts, programs, functions, executables, or other modules contained in the applications 258. In some implementations, the processor 260 can execute one or more threads of instructions in series or in parallel. The processor 260 can be a single-core processor or a multi-core processer. The processor 260 may perform one or more of the operations related to FIGS. 3-5. The input data received by the processor 260 or the output data generated by the processor 260 can include any of the treatment data, the geological data, the fracture data, the fluid data, or any other data.

FIG. 3 is a diagram of an example system architecture 300. The example system architecture 300 can be used to simulate a well system or another type of system that includes a subterranean region. For example, the architecture 300 can be used to simulate an injection treatment of the subterranean region 104 shown in FIG. 1. In some instances, the architecture 300 can be used to model fluid flow and other aspects of an injection treatment or other activities (e.g. drilling, production, etc.) in a well system. The example system architecture 300 shown in FIG. 3 can be used in connection with performing numerical simulations of a subterranean reservoir. For example, numerical simulations may include simulations of fluid flow in the porous media of the reservoir, fluid flow within fractures and wellbores, proppant transport in fluids, structural mechanics, heat flow, fluid-structure interactions, or other aspects of a stimulated subterranean region. In some implementations, the numerical simulations can be performed in real time during an injection treatment.

The example architecture 300 shown in FIG. 3 includes a well system 310, a data acquisition system 320, a simulation system 330, and an analysis system 360. The architecture 300 can include additional or different components or subsystems, and the example components shown in FIG. 3 can be combined, integrated, divided, or configured in another manner. For example, the simulation system 330 and the analysis system 360 can be subcomponents of an integrated computing system (e.g., the computing systems 200 shown in FIG. 2) or multiple computing systems; or the data acquisition system 320 can be integrated with the well system 310. As another example, the simulation system 330 or the analysis system 360, or both, can be implemented in a computing system that operates independent of the well system 310 or the data acquisition system 320.

The well system 310 can include a well system environment (e.g., the well system 100 shown in FIG. 1) or a subset of well system components or subsystems (e.g., the injection system 108 shown in FIG. 1). In some examples, the well system 310 includes a fluid system where fluid flow or other fluid phenomena occur. The well system 310 can include the physical reservoir rock in a subterranean reservoir (e.g., the subterranean region 104 shown in FIG. 1), fractures or a fracture network in the reservoir rock, one or more downhole systems installed in a wellbore, or a combination of them.

The data acquisition system 320 can be any system or hardware that obtains data from the well system 310. For example, the data acquisition system 320 can include flow sensors, pressure sensors, temperature sensors, microseismic sensors, and other types of measurement devices. The data acquisition system 320 can include communication and data storage systems that store, transfer, manipulate, or otherwise manage the information obtained from the well system.

The simulation system 330 can include one or more computer systems or computer-implemented programs that simulate aspects of a well system. The simulation system 330 can receive information related to the well system 310 and simulate fluid flow and other phenomena that occur in the well system 310. For example, the simulation system 330 can calculate flow velocities, pressures, temperature, or other aspects of fluid flow based on data from the data acquisition system 320 or another source. The example system architecture 300 may also simulate movement of mechanical systems (e.g. structural mechanics, rock blocks, reservoir media, wellbore equipment) or other phenomena coupled to the simulated fluid.

The example simulation system 330 includes well system data 332, a global system model 334, a solver 340, and a preconditioner 342. The simulation system can include additional or different features, and the features of a simulation system 330 can be configured to operate in another manner. The modules of the simulation system 330 can include hardware modules, software modules, or other types of modules. In some cases, the modules can be integrated with each other or with other system components. In some example implementations, the simulation system 330 can be implemented as software running on a computing system (e.g., the example computing systems 200 in FIG. 2), and the modules of the simulation system 330 can be implemented as software functions or routines that are executed by the computing system. In some implementations, one or more software functions or routines can include multiple threads that can be executed by computing system in series or in parallel.

The well system data 332 can include any information related to the example well system 310 or another well system. For example, the well system data 332 can indicate physical properties (e.g., geometry, surface properties, etc.) of one or more flow paths (e.g., fractures, wellbore, etc.) in the well system 310, material properties (e.g., density, viscosity, Reynolds number, etc.) of one or more fluids in the well system 310, thermodynamic data (e.g., fluid pressures, fluid temperatures, fluid flow rates, heat flow, etc.) measured at one or more locations in the well system 310, proppant properties (e.g., size, types, concentration, etc.) in one or more fluids, rock block data (e.g., location, orientation, deformation, displacement, stresses and strains) associated with one or more rock blocks in the well system 310, and other types of information. The well system data 332 can include information received from the data acquisition system 320 and other sources.

The global system model 334 can include any information or modules that can be used to simulate a subterranean region. The simulated subterranean region can include all or part of a well system, or the simulated subterranean region can be physically coupled to a well system. In some implementations, the simulated subterranean region does not include a well system. For example, the simulated subterranean region can be a candidate or prospective site for a well system. The global system model 334 can include governing equations, spatial and temporal discretization data, or other information. In some examples, the global system model 334 include governing flow equations, such as, for example, Navier-Stokes equations or related approximations of Navier-Stokes equations, continuity equations, linear elasticity equations, or other types of equations.

The global system model 334 can include various types of subsystem models for simulating a subterranean region. In some instances, the global system model 334 can include flow models that represent the fluid flow associated with distinct sub-regions in the subterranean region. For example, the flow models can include a wellbore subsystem model 335 for modeling fluid flow in a wellbore (e.g., wellbore 102 in FIG. 1) or a wellbore tool, a fracture subsystem model 336 for modeling fluid flow in fractures, a reservoir subsystem model 338 for modeling fluid flow in the reservoir media, a flow-back or leak-off model for modeling fluid flow flow-back or leak-off processes between reservoir rock and adjacent fractures, a rock block subsystem model 337 for modeling structural mechanics and solid-fluid interactions, or a combination of these and other types of subsystem models. In some instances, the global system model 334 can include or otherwise interact with additional or different subsystems models such as, for instance, subsystem models that models proppant transport in the fluids, and heat flow models that models heat flow in the subterranean region.

In some implementations, the subsystem models can be coupled, for example, by one or more coupling models 339 that can provide connection conditions, boundary conditions, or both among the subsystem models. The global system model 334 can include multiple instances of each type of the subsystem models. For example, the global system model 334 can include multiple fracture subsystem models representing fluid flow in multiple individual fractures within a fracture network; the global system model 334 can include multiple rock block subsystem models representing multiple distinct rock blocks within a subterranean region; etc.

The global system model 334 can include discretization data derived from governing equations (e.g., governing flow equations or other types of governing equations). For example, the global system model 334 can include spatial discretization data such as discrete nodes that represent locations of fluid flow along flow paths in the well system 310, or other types of data. The global system model 334 can also include temporal discretization data for the subsystem models. The data can be represented in various forms. In some implementations, discretized governing equations can be represented in matrix form. For example, some discretized governing equations can be represented by band matrix data and intersection data. Additional or different types of matrix representations can be used. In some instances, the global system model 334 can be a highly nonlinear, multi-scale, multi-physics model. The global system models 334 can include different subsystem models with different spatial and temporal scales. For instance, the fracture and wellbore subsystem models can use finer spatial discretization and represent faster fluid flow than the far field reservoir subsystem model.

In some implementations, the simulation system 330 can also include a time marching module to perform calculations in a discretized time domain. For example, the governing equations may include derivatives or partial derivatives in the time domain, and the time marching module can calculate such quantities based on a time marching algorithm. Example time marching schemes include the backward Euler scheme, the Crank-Nicolson scheme, and others.

The solver 340 can include any information or modules that can be used to solve a system of equations. For example, the solver 340 can include one or more of a direct solver, an iterative solver, or another type of solver. In some implementations, the solver 340 can include one or more solvers specialized for different applications. For example, the solver 340 can include a DAE (differential algebraic equations) solver, an ODE (ordinary differential equations) solver, a block-matrix solver, a band matrix solver, a sparse matrix solver, or other types of solvers. In some implementations, the solver 340 receives inputs from the other components of the simulation system 330 and generates a numerical solution for one or more variables of interest based on the inputs. The solution can be generated for each node in a discretized spatial domain. For example, the solver 340 may calculate values of fluid velocity, fluid pressure, or another variable over a spatial domain; the values can be calculated for an individual time step. In some cases, the solver 340 can be expressed as solving a matrix equation Ax=b, where x is the variable of interest that is computed by the solver 340, and elements of A and b are provided, for example, based on information from the global models 334 (or one or more of the subsystem models 335-339), the well system data 332, the preconditioner 342, and other sources.

In some implementations, the solver 340 can solve a global system of equations of the global system model 334 that encompasses multiple diverse aspects (e.g., wellbores, fractures, rock blocks, reservoirs, etc.) of the subterranean region. In some instances, the global system model 334 includes tightly coupled subsystem models and the solver 340 can solve them all together in a fully coupled, temporally implicit manner. For example, the overall system with tightly coupled models can be solved by defining a common solution vector for the multiple subsystem models, modifying the subsystem models (e.g., updating the parameters, dimensions, units, numerical formulation of the governing equations, etc.) to operate together based on the common solution vector, and in turn refining the common solution vector. In some other implementations, the solver 340 may first operate on one or more subsystem models independently. For example, in some instances, the calculations of multiple subsystem models can be performed in parallel. In some implementations, different types of solvers can be chosen for different subsystem models depending on the governing equations of each subsystem model. For example, band matrix solvers can be selected for subsystem models (e.g., fracture subsystem model, wellbore subsystem model, etc.) that include band matrices from discretization of their respective governing flow equations.

The preconditioner 342 can include any information or modules that can be used to precondition a model (e.g., the global system model 334, the subsystem models, other types of models, or a combination of these). For example, the preconditioner 342 can be used to transform a system of equations into another form (a preconditioned form), such as, for example, a form that may be easier or more efficient for the solver 340 to solve. In some instances, the preconditioner can cast all equations in single unit system to assure convergence. The preconditioner may operate, in some cases, by approximating the inverse of a system of linear equations. In some implementations, applying the preconditioner may include, for example, multiplying a preconditioner data object in a system of linear equations (e.g., in a matrix form). In some implementations, the preconditioner can be implemented as an operation, a function, a data object, or a combination of these. The preconditioner can receive an input (e.g., a vector) and generate an output (e.g., another vector). The preconditioner may be implemented in additional or different manners.

The preconditioner 342 can execute or otherwise perform any appropriate preconditioning algorithm. In some instances, the preconditioner 342 may include multiple modules and each module can implement a specialized preconditioning algorithm for a certain application. For example, the preconditioner 342 can include modules specialized for preconditioning methods such as, for example, the power method, the Arnoldi method, the multigrid method, Tikhonov regularization, or other types of the precondition methods. In some implementations, the evaluation or application of the preconditioner can be implemented by a solver (e.g., the solver 340 or another solver). As an example, a band matrix solver may be adapted or otherwise used as a preconditioner to precondition a band matrix. As another example, a Krylov subspace linear solver or another type of solver can be used to implement preconditioning in a matrix-free manner.

The analysis system 360 can include any systems, components, or modules that analyze, process, use, or access the simulation data generated by the simulation system 330. For example, the analysis system 360 can include a real-time analysis system that displays or otherwise presents well data (e.g., to a field engineer, etc.) during an injection treatment. For instance, the analysis system 360 may display simulated fracture network, fluid data, or other types of information. In some cases, the analysis system 360 can be a fracture simulation suite that simulates fracture propagation based on the simulated fluid flow data. As another example, the analysis system 360 can be a reservoir simulation suite that simulates fluid migration in a reservoir. The analysis system 360 can include other simulators or a simulation manager that simulates other aspects of a well system.

FIG. 4 is a flow chart of an example process 400 for operating a subterranean region model. In some instances, the example process 400 can be used for simulating a subterranean region (e.g., the subterranean region 104 as shown in FIG. 1 or another type of subterranean region). Some or all of the operations in the process 400 can be implemented by one or more computing system, such as, for example, the example computing system 200 in FIG. 2. In some implementations, the process 400 includes additional, fewer, or different operations, and the operations can be performed in the order shown or in a different order. Moreover, one or more of the individual operations or subsets of the operations in the process 400 can be performed in isolation or in other contexts.

In some implementations, some or all of the operations in the process 400 are executed in real time during a treatment or another type of well system activity. An operation can be performed in real time, for example, by performing the operation in response to receiving data (e.g., from a sensor or monitoring system) without substantial delay. Also, an operation can be performed in real time by performing the operation while monitoring for additional data (e.g., from a treatment or other activities). Some real time operations can receive an input and produce an output during a treatment; in some instances, the output is made available to a user within a time frame that allows the user to respond to the output, for example, by modifying the treatment.

At 410, subsystem models of a global system model are identified. In some implementations, the global system model can represent a subterranean region that is associated with a stimulation treatment or another type of the well system activity. The global system model can be the global system model 334 described with respect to FIG. 2, or another type of global system model. The subsystem models can represent distinct physical subsystems within a subterranean region. For example, the subsystem models can include one or more wellbore subsystem models, fracture subsystem models, rock-block subsystem models, reservoir subsystem models, heat flow subsystem models, proppant transport subsystem models, or additional or different models. The global system model can also include coupling models that represent the coupling or other interactions among the subsystem models. The coupling models can provide boundary conditions, connection conditions or other conditions of the overall simulation system.

In some implementations, each subsystem model may include respective variables and governing equations that represent physical dynamics associated with a sub-region in the subterranean region. For example, the fracture, wellbore, and reservoir subsystem models can include governing flow equations and one or more fluid flow variables. The rock-block subsystem model can include governing equations that capture the solid-fluid interactions. In some instances, the fracture subsystem model and wellbore subsystem model can be governed by the Navier-Stokes equations. The reservoir subsystem model can model fluid flow in the porous media of the reservoir based on Darcy flow governing equations. The rock-block subsystem model may be governed by the equations of linear elasticity to represent the structural mechanics. In some implementations, identifying the subsystem models includes identifying the governing equations (e.g., including the associated variables and coefficients) of each of the subsystem models.

In some instances, each subsystem model can have its own governing equations with its own numerical discretization, independent of the other subsystem models. The discretization of each subsystem model can result in a local system of discrete equations with finitely many variables. For example, in some cases, the local discrete system can be expressed as a linear system, Ax=b, where A is a coefficient matrix, x is a vector of unknown variables, and b is a vector of data. In some cases, nonlinear systems can be linearized and solved, for example, by the Newton-Raphson method or another method. In such cases, each iteration of the nonlinear solver includes solving a linear system, Ju=f, where J is the Jacobian of the nonlinear discrete equations, u is an update vector for the iterative solution, and f is a residual vector. In both linear and nonlinear cases, solving each individual model includes solving a linear system of equations. Similarly, solving the global system model can include solving a global linear system of equations.

In some implementations, the global system of equations can be denoted Ax=b, which can come from linear equations, nonlinear equations, or a combination thereof. The global coefficient matrix A can include, for example, sub-matrices corresponding to the subsystem models (e.g., as diagonal blocks or sub-matrices) and off-diagonal blocks corresponding to the coupling models that represent the interactions of the subsystem models. The matrix entries in the global coefficient matrix A can be coefficients or other values from the governing equations of the subsystem models and coupling models. The vector x can include variables of the subsystem models. For example, the vector x can include fluid flow variables (e.g., fluid pressure, velocity, temperature, etc.), rock-block variables (e.g., location, orientation, stresses and strains, deformation, displacement of the rock block, etc.) and other types of variables. Solving the global system Ax=b can include obtaining a full solution vector x of the variables of the global system.

In some implementations, the global system Ax=b can be solved by direct, iterative, or other types of methods. Direct methods attempt to solve a problem by a finite sequence of operations. In some instances, in the absence of rounding errors, direct methods can deliver an exact solution (e.g., by Gaussian elimination or a variant thereof). Iterative methods often use an initial guess to generate successive approximations to a solution. For example, the solution in an iteration of the iterative methods can be obtained by modifying or otherwise updating the solution based on a solution obtained in a previous iteration. The iterative methods can include termination criteria and the iterative algorithms can terminate when the termination criteria are satisfied.

In some instances, the global linear system can be large in size, and iterative methods, for example, Krylov subspace method, can provide advantages in computational complexity and scalability in parallel computing. The efficiency of directly-applied iterative methods can depend on the condition number of the coefficient matrix A of the global linear system. In some instances, the condition number of the global coefficient matrix A can be large due to, for example, coupling of the local coefficient matrices of the subsystem models, the size of the global system model, etc. Applying a preconditioner P to the linear system can help generate a well-conditioned matrix PA.

In some cases, iterative methods can be more efficient in solving the preconditioned system. In some implementations, the iterative methods can include multiple iterations. Within each iteration, the global system model can be preconditioned, for example, based on some or all of the example techniques described at 420 and 430, or another technique. In some implementations, the solution to a preconditioned system in one iteration can be used in a next iteration to update and obtain a successive approximation of the solution to the original global system Ax=b. In some implementations, preconditioning the global system model can include multiple levels of preconditioning.

At 420, local preconditioning is performed. In some instances, local preconditioning can include applying a respective local preconditioner to each individual subsystem model of the global system model. The preconditioning operations applied to an individual model can be determined based on the physics of the subsystem represented by the individual model. Here, the physics of the subsystem refers to the dominant physical processes that govern the modeled behavior of the subsystem. The dominant physical processes of the subsystem are typically embodied in the governing equations of the model. As such, the subsystem models can be preconditioned based on their respective governing equations (including the parameters of their respective governing equations). For example, a fracture subsystem model can be preconditioned based on a governing flow equation of the fracture model; a wellbore model can be preconditioned based on a governing flow equation of the wellbore model; a reservoir model can be based on a governing fluid equation of the reservoir model; and a rock block model can be based on a governing equation of the rock block model.

In some implementations, discretization of the governing flow equations can result in a band matrix. A band matrix (also called a banded matrix) includes a diagonal band of matrix elements. In some instances, all non-zero elements of the band matrix reside within a bandwidth about the main diagonal (including the main diagonal) while all elements outside the bandwidth of the band matrix can be zero. In some implementations, a subsystem model having a banded discretization matrix with a small bandwidth may be preconditioned by solving the band matrix using direct band matrix solvers. A direct band matrix solver can include direct methods for solving a band matrix. For example, a direct band matrix solver may include Gaussian elimination, a variant thereof, or other techniques for solving the band matrix.

In some implementations, a subsystem model having a banded discretization matrix or a small-sized matrix can be preconditioned by performing LU factorization on the band matrix. The LU factorization (also known as LU decomposition) decomposes the matrix into a product of a lower triangular matrix and an upper triangular matrix. Some models may have few variables, allowing fast LU factorization. In some implementations, preconditioning a band matrix via LU factorization on the band matrix can include performing a banded incomplete LU factorization of the band matrix. The incomplete LU factorization is a sparse approximation of the LU factorization.

As another example, a subsystem model described by elliptic or parabolic partial differential equations may be preconditioned based on a multigrid method. A multigrid method includes algorithms for solving differential equations using a hierarchy of discretizations. For example, a multigrid method with an intentionally reduced tolerance can be used as an efficient preconditioner for an iterative solver. Additional or different preconditioning techniques can be applied to the subsystem models.

In some instances, given a global coefficient matrix A that includes diagonal blocks corresponding to local coefficient matrices of the subsystem models, preconditioning multiple subsystem models can be effectively represented, for example, by a block-diagonal preconditioner P_{BD} pre-multiplying both sides of the system of equations Ax=b. The block-diagonal preconditioner P_{BD} can be a block-diagonal matrix that includes local preconditioners for the respective multiple subsystem models as non-zero blocks (or sub-matrices) residing in and about the main diagonal. As a result, the preconditioned global system of equations can be represented by P_{BD} Ax=P_{BD}b. The block-diagonal preconditioner P_{BD} neglects the off-diagonal coupling blocks of the global coefficient matrix A. However, the neglected off-diagonal blocks are typically of low dimension, relative to the size of the global matrix A. For example, the off-diagonal blocks based on the coupling models may be confined to variables on the physical interface between two subsystem models, which may have far fewer variables than each subsystem model. Consequently, the preconditioned system, e.g., P_{BD} Ax=P_{BD}b, can have a high condition number, but only a small number of extreme eigenvalues. Extreme eigenvalues are eigenvalues with very large or small magnitude relative to the other eigenvalues of the system. For example, the extreme eigenvalues can be orders of magnitude larger or smaller than the other eigenvalues. In some implementations, a global preconditioner can be further applied to the preconditioned system P_{BD}Ax=P_{BD}b, for example, based on example operations described at 430. In some implementations, the preconditioner P_{BD} is not necessarily a matrix. It can be a function or operator, for example, defined by applying local functions or operators to each subsystem model.

In some implementations, two or more of the subsystem models can be grouped together and define a composite subsystem model. Local preconditioning can include preconditioning the composite subsystem model. As an example, multiple fracture subsystem models that represent fracture segments of the fracture network can form a composite subsystem model and a joint local preconditioner can be applied to the composite subsystem model. In some implementations, different subsystem models can be selected to form different composite subsystem models, for example, based on the coupling among the subsystem models. In some instances, multiple composite subsystem models can have mutually exclusive subsystem models, or they may share one or more common subsystem models. Respective preconditioners for the multiple composite subsystem models can be determined, for example, based on underlying physics represented by the composite subsystems, the governing equations, the coefficient matrix structure of the composite subsystem models, or other factors. In some implementations, the respective preconditioners can be applied to the multiple composite subsystem models in parallel or in series.

In some instances, the local preconditioning can include a hierarchy of preconditioning. As an example, a hierarchical preconditioning process can be applied to a global system of equations, where the root level of hierarchy includes applying a preconditioner to each subsystem model of the global system model (e.g., in the form of a block-diagonal preconditioner) while one or more higher levels of the hierarchy includes applying preconditioners to one or more composite subsystem models. The hierarchical preconditioning may be implemented in another order. In some instances, within each hierarchical level of the preconditioning, one or more preconditioner can be applied in parallel. The local preconditioning operations may include additional or different preconditioning techniques, or the preconditioning techniques may be applied in a different manner.

At 430, global preconditioning is performed. In some instances, the global preconditioning can include applying a global preconditioner to the global system model that includes the preconditioned subsystem models. For instance, a global preconditioner P_{G} can be applied to the locally preconditioned global system P_{BD}Ax=P_{BD}b or another type of preconditioned global system. The global preconditioning can be based on, for example, multigrid methods, deflation methods, Tikhonov iterations, or other types of techniques.

In some instances, global preconditioning can be performed based on an algebraic multigrid (AMG) method. The AMG method can be effective for many matrices without using any knowledge of the underlying mathematical problem being solved numerically. As such, AMG can be used as the global preconditioner and applied to the global coefficient matrix, since it is not limited to a particular type of equation or model. In some cases, however, AMG may not be directly applicable because it may require knowledge of entries of the matrix. When the entries of the global matrix are not readily available, AMG may be less efficient due to the computation of entries of the matrix. For example, in the case of nonlinear equations, the matrix of the linear system can include one or more Jacobians; in many applications, the Jacobian is not known analytically, and the action of the Jacobian on a vector is approximated by finite differences.

In some instances, global preconditioning can be performed based on the method of deflation. The method of deflation includes solving a system separately in orthogonal subspaces. Deflation preconditioning can include constructing a subspace of the full vector space of unknown variables. The subspace can be referred to as the deflation subspace, which can include, for example, the span of the eigenvectors associated with the extreme eigenvalues. The deflation subspace can be relatively low-dimensional, so that the coefficient matrix projected onto the subspace is small enough that direct methods or LU factorization can be performed efficiently. Accordingly, the linear system can be solved quickly in the subspace. Deflation preconditioning can be applied to both symmetric and non-symmetric matrices. As an example, deflation preconditioning can be applied to the preconditioned global matrix P_{BD}A that is typically non-symmetric. Extreme eigenvalues of the preconditioned global matrix P_{BD}A and their corresponding eigenvectors can be calculated and the deflation subspace that includes the span of the eigenvectors associated with the extreme eigenvalues can be computed. The preconditioned global system P_{BD}A=P_{BD}b can be projected and solved in the deflation subspace. The remaining component of the solution thus lies in the orthogonal complement of the deflation subspace, where the matrix P_{BD}A is well conditioned, thanks to the removal of the extreme eigenvalues. An iterative method applied to the linear system in the orthogonal complement can therefore converge fast. Consequently, the full solution can be obtained fast, yielding the result of the global preconditioner applied to the vector b. In some implementations, the deflation method can be implemented without storing the matrix P_{BD}A. For example, the deflation method can be performed by performing the action of the matrix (e.g., matrix-vector product).

Deflation preconditioning can include calculating eigenvectors associated with the extreme eigenvalues. In some implementations, efficient computation of the eigenvectors without storing the matrix P_{BD}A can be done, for example, by the power method (or power iteration), Arnoldi method (or Arnoldi iteration), etc. Some implementations of these methods include, for example, the implicitly restarted Arnoldi method (IRAM) that restarts after some number of iterations. In some cases, IRAM can be efficient in computing the eigenvectors associated with the extreme eigenvalues for the preconditioned global system. IRAM can be performed, for example, using the ARPACK package (the ARnoldi PACKage), a conventional numerical software library for solving large scale eigenvalue problems. Based on these methods, any number of the largest (in magnitude or in real part) eigenvalues and corresponding eigenvectors can be computed. The smallest (in magnitude or in real part) can also be computed, for example, by using shift transformations of the spectrum. In some instances, for example, when P_{BD}A is ill-conditioned, accurate computation of the extreme eigenvalues and the associated eigenvectors may require an implementation using high precision arithmetic or other appropriate techniques. As a result, preconditioning based on the method of deflation can be efficiently implemented, for example, in a matrix-free fashion in some instances.

In some instances, global preconditioning can be performed based on Tikhonov regularization. Tikhonov regularization is method of regularization of ill-posed problems, for example, by introducing additional information in order to solve an ill-posed problem. Tikhonov regularization generally aims to achieve a trade-off between solving the ill-posed problem (e.g., via fitting data) and reducing a norm of the solution. Tikhonov preconditioning can be a preconditioning technique adapted from Tikhonov regularization. For instance, Tikhonov preconditioning can include shifting the eigenvalues of the coefficient matrix by a regularization parameter (e.g., a constant value, or another type of numerical value), thus eliminating small eigenvalues. In some implementations, this can be achieved by adding to the global coefficient matrix an identity matrix scaled by the regularization parameter, which generates a shifted global coefficient matrix. The system of equations based on the shifted global coefficient matrix can be referred to as a shifted system. The shifted system can be better conditioned and thus can be solved more easily and efficiently, for example, by applying an iterative method (e.g. a Krylov method such as generalized minimal residual method (GMRES)). In some implementations, an approximate solution rather than a precise solution to the shifted system can be obtained, which can further reduce the computational requirement.

In some implementations, multiple regularization parameters can be used and result in multiple shifted systems. The regularization parameters can include constant values, values that are computed based on the global system model or other factors, or a combination of constants and other values. The multiple solutions to the multiple shifted systems can be extrapolated or otherwise manipulated to get a better approximation of the solution of the original problem (which corresponds to the regularization parameter being zero). The multiple solutions can be manipulated based on the example extrapolation techniques described with respect to FIG. 5, or in another manner. Using more regularization parameters and extrapolating may yield a more effective preconditioner, though with higher computational complexity.

Using a Tikhonov preconditioner can have several advantages. For example, the Tikhonov preconditioner can be implemented by a matrix-free method, using only the computations of matrix-vector products without the need to store the coefficient matrix explicitly. Additionally, using the Tikhonov preconditioner can be time-efficient, for example, by producing a well-conditioned system that can be solved quickly (e.g., the shifted system with the shifted global coefficient matrix). Moreover, the solution does not need to be computed precisely in some instances. The solution can be approximated with a small number of iterations of some iterative linear solver. Furthermore, in some cases, the Tikhonov preconditioner does not require computation of eigenvalues and eigenvectors, nor does it require a good estimate of the extreme eigenvalues. In some instances, the Tikhonov preconditioner can be effective even without a precise choice of the regularization parameter based on eigenvalue estimates. As such, the Tikhonov preconditioner may be preferable, for example, in ill-conditioned systems for which eigenvalue computation is numerically challenging.

At 440, the preconditioned global system model is operated. The preconditioned global system can be the global system preconditioned by both local preconditioner and global preconditioner. For example, after the local preconditioning and global preconditioning performed at 420 and 430, the preconditioned global system e.g., P_{G}P_{BD}A=P_{G}P_{BD}b, can be better conditioned and can be solved more easily. In some instances, operating the preconditioned global system model can include solving the original global system based on the preconditioned global system model. In the case of an iterative method, the solution (including an approximated solution) to the preconditioned system can be used in a next iteration to better approximate or otherwise update the solution to original global system model. In some implementations, operating the preconditioned global system model can include repeating some or all operations of the example process 400 until the iterative method converges, or another terminating condition is reached.

FIG. 5 is a flow chart of an example process 500 for preconditioning a subterranean model. In some instances, the example process 500 can be used for all or part of the global or local preconditioning described in FIG. 4. As an example, the process 500 can be used to implement Tikhonov preconditioning. In some other instances, the example process 500 can be used in another context. Some or all of the operations in the process 500 can be implemented by one or more computing system, such as, for example, the example computing system 200 in FIG. 2. In some implementations, the process 500 includes additional, fewer, or different operations, and the operations can be performed in the order shown or in a different order. Moreover, one or more of the individual operations or subsets of the operations in the process 500 can be performed in isolation or in other contexts.

At 510, a global coefficient matrix of a global system model can be identified. For example, a global coefficient matrix C of a global system model Cx=d can be identified. The vector x can be a vector of variables of the global system model and the vector b can include parameters of the global system model. The global system of equations Cx=d can be the same as the global system Ax=b described with respect to FIG. 4, or it can represent another global system of equations. In some instances, the global system model can be the global system model 334 as described with respect to FIG. 3, the example global system model described with respect to FIG. 4, or another system model.

The global system model can include multiple preconditioned subsystem models. Each of the subsystem models can represent a distinct subsystem within the subterranean region and each can include a respective governing equation. In some instances, some or all of the subsystem models can be preconditioned, for example, according to the example local preconditioning techniques described with respect to FIG. 4 or in another manner. For example, the subsystem models may be preconditioned based on the respective governing equations of the subsystem model. In some instances, one or more of the subsystem models may be preconditioned more than one time, for example, by a multi-level preconditioning process.

The global coefficient matrix can include coefficient matrices associated with multiple subsystem models. For instance, the global coefficient matrix can include coefficient matrices resulting from discretization of the governing equations of the subsystem models. In some implementations, the global coefficient matrix can be a large sparse matrix that includes diagonal sub-matrices corresponding to the coefficient matrices of the subsystem models and off-diagonal sub-matrices corresponding to the coefficient matrices of the coupling models that represent the coupling or connections among the subsystem models. In some implementations, the global coefficient matrix may include other types of elements and may have another structure.

At 520, eigenvalues of the global coefficient matrix can be shifted. For example, the eigenvalues of the global coefficient matrix C can be shifted by a regularization parameter λ₁, resulting in a shifted global coefficient matrix D₁. In some implementations, the shifted global coefficient matrix D₁ can be generated by adding a regularization term E to the global coefficient matrix C. The regularization term E can be, for example, λ₁l, the regularization parameter λ₁ times an identity matrix or another type of matrix. In this case, the shifted global coefficient matrix D₁=C+λ₁l. When the regularization parameter λ₁=0, the global system remains un-shifted and reduces to the original global system. In some implementations, the regularization parameter λ₁ can be chosen such that small eigenvalues of the global coefficient matrix C can be eliminated and thus the condition number of the shifted global coefficient matrix D₁ is reduced compared to the original global coefficient matrix C. As such, the shifted global system represented by the shifted global coefficient matrix D₁ can be solved more efficiently than the original global system with the original global coefficient matrix C.

At 530, the shifted global system represented by the shifted global coefficient matrix can be solved. For example, the shifted global system can be solved using a direct method, an iterative method (e.g., GMRES), or other types of techniques. In some implementations, solving the shifted global system can include obtaining an approximated solution to the shifted global system. For instance, the approximated solution can be obtained using only a small number of iterations of an iterative solver. In some implementations, the approximation can be used to define the preconditioned vector. For example, the solution of the shifted global system can be the output vector of the preconditioner (but the solution need not be exact). Solving the shifted global system with a small number of iterations of an iterative solver can be equivalent to multiplication by a preconditioner. The solution to the shifted global system can be used to approximate or otherwise update the solution to the original global system with the global coefficient matrix C.

In some implementations, the example process 500 can use multiple regularization parameters λ₁, λ₂, . . . λₖ. For instance, the example process 500 can further include shifting eigenvalues of the global coefficient matrix C by one or more different regularization parameters λ₂, . . . λₖ, which can generate one or more additional shifted coefficient matrices Dᵢ=C+λᵢl, for i=2, . . . k. Solutions to the shifted global systems with the shifted coefficient matrices {Dᵢ} can be obtained, for example, in a similar or different manner for solving the shifted global system with the shifted global coefficient matrix D₁. In some implementations, an extrapolated solution can be determined by extrapolating the k solutions based on the k regularization parameters. In this case, solving the original global system model Cx=d can include solving the global system model based on the extrapolated solution. The extrapolated solution can be an improved approximation to the solution of the original system, and thereby can improve the preconditioning result.

An example extrapolation technique is described as follows. In some implementations, the solution to the shifted system with a shifted coefficient matrix D can be represented as a linear combination of the right-singular vectors (obtained by the singular value decomposition of the shifted coefficient matrix D) with linear combination coefficients being rational functions of the regularization parameter λ (e.g., fⱼ(λ)=aⱼ/(bⱼ+λ), for some constants aⱼ and bⱼ). This representation would provide the solution to the original system when λ=0, if the coefficients and right-singular vectors were known. In practice, such a representation may be unknown, but it can be approximated by a linear combination of k vectors, with the linear combination coefficients being rational functions of λ. The vectors and coefficients can be determined by interpolating the k computed solutions for the k regularization parameters λ₁, λ₂, . . . λₖ, which yields a vector-valued function of λ, approximating the solution of the shifted system for any value of λ. Evaluating the function at λ=0 can generate an example extrapolated solution that can serve as the improved approximation to the solution of the original system. In some implementations, the multiple solutions to the shifted global systems can be extrapolated or manipulated in another manner to derive an improved approximation of the original global system.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., as one or more modules of computer program instructions encoded on a computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including, by way of example, a programmable processor, a computer, a system on a chip, or multiple ones, or combinations of the foregoing. The apparatus can include special purpose logic circuitry, e.g., an FPGA (Field Programmable Gate Array) or an ASIC (Application Specific Integrated Circuit). The apparatus can also include, in addition to hardware, code that creates an execution environment for the computer program in question; for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code), can be written in any form of programming language, including compiled or interpreted languages, or declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site, or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (Field Programmable Gate Array) or an ASIC (Application Specific Integrated Circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions, and one or more memory devices for storing instructions and data. A computer may also include, or be operatively coupled to receive data from or transfer data to, or both, one or more mass storage devices for storing data, (e.g., magnetic, magneto optical disks, or optical disks). However, a computer need not have such devices. Devices suitable for storing computer program instructions and data include all forms of non-volatile memory, media and memory devices, including, by way of example, semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

A computing system can include one or more computers that operate in proximity to one another or remote from each other, and interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise, for example, by virtue of computer programs running on the respective computers and having a client-server relationship to each other.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications can be made. Accordingly, other embodiments are within the scope of the following claims.

1. A computer-implemented method of operating a subterranean region model, the method comprising:
identifying subsystem models of a global system model that represents a subterranean region, each of the subsystem models representing a distinct subsystem within the subterranean region and being associated with a respective governing equation;
preconditioning, by operation of one or more computers, the subsystem models based on the respective governing equations of the subsystem models;
preconditioning the global system model that includes the preconditioned subsystem models; and
operating the preconditioned global system model.

2. The method of claim 1, wherein the subsystems models are coupled to each other in the global system model, and the global system model comprises coupling models that represent interactions among the subsystem models.

3. The method of claim 1, comprising:
defining a composite subsystem model comprising two or more of the subsystem models; and
preconditioning the composite subsystem model.

4. The method of claim 1, wherein preconditioning the subsystem models comprising one or more of:
preconditioning a fracture model that represents well system fluid flow within a fracture in the subterranean region based on a governing flow equation of the fracture model;
preconditioning a wellbore model that represents well system fluid flow within a wellbore in the subterranean region based on a governing flow equation of the wellbore model;
preconditioning a reservoir model that represents well system fluid flow within a reservoir medium in the subterranean region based on a governing fluid equation of the reservoir model; or
preconditioning a rock block model that represents structural mechanics of rock blocks in the subterranean region based on a governing equation of the rock block model.

5. The method of claim 1, wherein at least one of the subsystem models includes a band matrix and preconditioning the subsystem models comprises:
solving the band matrix using a direct band matrix solver; or
performing an LU factorization of the band matrix.

6. The method of claim 1, wherein preconditioning the subsystem models comprises applying a multigrid preconditioning on a subsystem model that includes a partial differential equation.

7. The method of claim 1, wherein preconditioning the global system model comprises calculating matrix-vector products without explicitly storing a global coefficient matrix of the global system model.

8. The method of claim 1, wherein preconditioning the global system model comprises performing Tikhonov preconditioning.

9. The method of claim 1, wherein preconditioning the global system model comprising performing a deflation preconditioning.

10. The method of claim 1, wherein operating the preconditioned global system model comprises solving the preconditioned global system model.

11. A non-transitory computer-readable medium storing instructions that, when executed by data processing apparatus, perform operations comprising:
identifying subsystem models of a global system model that represents a subterranean region, each of the subsystem models representing a distinct subsystem within the subterranean region and being associated with a respective governing equation;
preconditioning the subsystem models based on the respective governing equations of the subsystem models;
preconditioning the global system model that includes the preconditioned subsystem models; and
operating the preconditioned global system model.

12. The computer-readable medium of claim 11, the operations comprising:
defining a composite subsystem model comprising two or more of the subsystem models; and
preconditioning the composite subsystem model.

13. The computer-readable medium of claim 11, wherein preconditioning the global system model comprises calculating matrix-vector products without explicitly storing a global coefficient matrix corresponding to the global system model.

14. The computer-readable medium of claim 11, wherein preconditioning the global system model comprises performing Tikhonov preconditioning.

15. The computer-readable medium of claim 11, wherein preconditioning the global system model comprising performing a deflation preconditioning.

16. A subterranean region modeling system comprising one or more computers that include:
memory operable to store subsystem models of a global system model that represents a subterranean region, each of the subsystem models representing a distinct subsystem within the subterranean region and being associated with a respective governing equation; and
data processing apparatus operable to:
precondition the subsystem models based on the respective governing equations of the subsystem models;
precondition the global system model that includes the preconditioned subsystem models; and
operate the preconditioned global system model.

17. The subterranean region modeling system of claim 16, the data processing apparatus being operable to:
define a composite subsystem model comprising two or more of the subsystem models; and
precondition the composite subsystem model.

18. The subterranean region modeling system of claim 16, the data processing apparatus being operable to calculate matrix-vector products without explicitly storing a global coefficient matrix corresponding to the global system model.

19. The subterranean region modeling system of claim 16, the data processing apparatus being operable to precondition the global system model by performing Tikhonov preconditioning.

20. The subterranean region modeling system of claim 16, the data processing apparatus being operable to precondition the global system model by performing a deflation preconditioning.
